(19) United States
(12) Patent Application Publication
(10) Pub. No.: US 2026/0172979 A1
(43) Pub. Date: Jun. 18, 2026

(54) PUCCH POWER CONTROL ENHANCEMENT

(71) Applicant: QUALCOMM Incorporated, San Diego, CA (US)

(72) Inventors: Yi HUANG, San Diego, CA (US); Wei YANG, San Diego, CA (US); Xiao Feng WANG, San Diego, CA (US); Gabi SARKIS, San Diego, CA (US); Jing JIANG, San Diego, CA (US); Jing SUN, San Diego, CA (US)

(21) Appl. No.: 18/978,727

(22) Filed: Dec. 12, 2024

(51) Int. Cl. H04W 52/14; H04W 52/22

(52) U.S. Cl. CPC H04W 52/146; H04W 52/225

(57) ABSTRACT

Aspects relate to mechanisms for physical uplink control channel (PUCCH) power control based on a power control offset. The power control offset may be based on at least one of a payload type of the PUCCH, a number of uplink control information (UCI) bits, or an encoder type of the PUCCH. In some examples, the power control offset may further be configured by the network and provided to the UE.

### TECHNICAL FIELD

The technology discussed below relates generally to wireless communication systems, and more particularly, to power control of physical uplink control channel (PUCCH) transmissions.

### INTRODUCTION

In wireless communication systems, such as those specified under fifth generation (5G) systems, referred to as New Radio (NR) systems, sixth generation (6G) systems, and other future generations, a user equipment (UE) may be capable of communicating with a network entity over an air interface. Transmissions over the air interface from the network entity to the UE may be referred to as downlink (DL) transmissions, whereas transmissions over the air interface from the UE to the network entity may be referred to as uplink (UL) transmissions. In a DL transmission, the network entity may transmit DL control information (DCI) including one or more DL control channels, such as a physical downlink control channel (PDCCH), to the UE. In addition, the network entity may transmit DL data traffic on one or more DL traffic channels, such as a physical downlink shared channel (PDSCH), to the UE. In an UL transmission, the UE may transmit UL control information (UCI) including one or more UL control channels, such as a physical uplink control channel (PUCCH), to the network entity. In addition, the UE may transmit UL data traffic on one or more UL traffic channels, such as a physical uplink shared channel (PUSCH), to the network entity.

The transmit power of UL transmissions, such as PUCCH and PUSCH transmissions, may be increased or decreased to meet requirements of the network. For example, the power of uplink transmissions may be increased to meet signal-to-noise ratio (SNR) or block error rate (BER) requirements at the network entity. Transmit power of uplink transmissions may also be decreased to minimize co-channel interference in the wireless system. A UE may support open loop and/or closed loop uplink power control to modify the transmit power of UL transmissions. Open-loop power control adjusts the uplink transmit power without feedback from the network, whereas in closed-loop power control, feedback from the network is used in adjusting the uplink transmit power.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) is provided. The UE includes one or more memories and one or more processors coupled to the one or more memories. The one or processors are configured to configure a transmit power of a physical uplink control channel (PUCCH). The transmit power has a payload size dependent offset and an additional power control offset based on at least one of a payload type, a number of uplink control information (UCI) bits, or an encoder type. The one or more processors are further configured to transmit the PUCCH at the transmit power to a network entity.

Another example provides a method operable at a user equipment (UE). The method includes configuring a transmit power of a physical uplink control channel (PUCCH). The transmit power has a payload size dependent offset and an additional power control offset based on at least one of a payload type, a number of uplink control information (UCI) bits, or an encoder type. The method further includes transmitting the PUCCH at the transmit power to a network entity.

Another example provides an apparatus configured for wireless communication. The apparatus includes means for configuring a transmit power of a physical uplink control channel (PUCCH). The transmit power has a payload size dependent offset and an additional power control offset based on at least one of a payload type, a number of uplink control information (UCI) bits, or an encoder type. The apparatus further includes means for transmitting the PUCCH at the transmit power to a network entity.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the features discussed herein. In other words, while one or more examples may be discussed as having certain features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram providing a high-level illustration of one example of a configuration of a disaggregated base station according to some aspects.

FIGS. 3A, 3B, 3C, and 3D are diagrams illustrating examples of a first 5G/NR frame, DL channels within a 5G/NR subframe, a second 5G/NR frame, and UL channels within a 5G/NR subframe, respectively.

FIG. 4 is a diagram illustrating an example of physical uplink control channel (PUCCH) formats according to some aspects.

FIGS. 5A and 5B are diagrams illustrating examples of long PUCCH and short PUCCH according to some aspects.

FIG. 6 is a diagram illustrating a power profile of a payload size dependent offset based on the payload size of a PUCCH according to some aspects.

FIG. 7 is a diagram illustrating an example of a UE 700 configured to generate a PUCCH at a particular transmit power according to some aspects.

FIG. 8 is a signaling diagram illustrating exemplary signaling between a UE and a network entity for configuring a transmit power of a PUCCH according to some aspects.

FIG. 9 is another signaling diagram illustrating exemplary signaling between a UE and a network entity for configuring a transmit power of a PUCCH according to some aspects.

FIG. 10 is a block diagram illustrating an example of a hardware implementation for a UE employing a processing system according to some aspects.

FIG. 11 is a flow chart illustrating an exemplary process for a UE to configure a transmit power of a PUCCH according to some aspects.

FIG. 12 is a block diagram illustrating an example of a hardware implementation for a network entity employing a processing system according to some aspects.

FIG. 13 is a flow chart illustrating an exemplary process for a network entity to configure a power control offset for a transmit power of a PUCCH according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., network entity and/or UE), end-user devices, etc., of varying sizes, shapes, and constitution.

Power control of physical uplink control channel (PUCCH) transmissions utilizes both open-loop and closed-loop power control information, along with various power offsets to account for different bandwidths, different path losses, different PUCCH formats, and different PUCCH payload sizes. For example, a PUCCH payload size dependent power adjustment term (e.g., a payload size dependent offset) may be set using a logarithmic function for payload sizes less than or equal to 11 uplink control information (UCI) bits (#UCI bits<=11) and an exponential function for payload sizes greater than 11 UCI bits (#UCI bits>11). However, the transition between 11 and 12 UCI bits experiences an undesired dip in the power offset due to the use of two different functions. This dip is not explained by the difference in encoder types used for the different payload size ranges. For example, UCI bits are encoded with a Reed Muller encoder when the number of UCI bits is less than or equal to 11, and with a polar encoder when the number of UCI bits is greater than 11. Different encoders may yield different coding gains, thus necessitating different transmit powers. However, the power offset dip between 11 and 12 bits is significantly larger than the expected coding gain difference for the different encoder types. Moreover, there is currently no power offset provided based on the type of PUCCH payload (e.g., scheduling request (SR), acknowledgement information (hybrid automatic repeat request (HARQ)-acknowledgement (ACK)), and/or channel state information (CSI)).

Various aspects are related to mechanisms for a power control offset based on at least one of a number of UCI bits, an encoder type, or a payload type of the PUCCH. For example, a power control offset based on the number of UCI bits or encoder type may be provided to smooth the transmit power in the transition between eleven to twelve UCI bits. For example, a Delta_encoder or Delta_payload_size power offset may be set to 0 dB for a Reed Muller encoder or number of UCI bits less than or equal to eleven, and 3 dB for a polar encoder or a number of UCI bits greater than eleven. As another example, a power control offset based on the PUCCH payload type dependent power offset (Delta_payload_type) may be provided to account for different performance requirements for different PUCCH payload types.

In some examples, the Delta_encoder or Delta_payload size power offset may be a fixed offset added to a PUCCH power control equation including the payload size dependent offset (PUCCH payload size dependent power adjustment term). In other examples, the Delta_encoder or Delta_payload size power offset may be a fixed offset added to the payload size dependent offset for payload sizes over 11 UCI bits (e.g., to the PUCCH payload size dependent power adjustment term using an exponential function). In some examples, the Delta_payload_type may be a fixed offset added to the PUCCH power control equation. For example, the PUCCH power control equation may include an open loop power control parameter, a closed loop power control parameter, an uplink PUCCH format offset, a path loss parameter, a bandwidth parameter, the payload size dependent offset, and the Delta_payload_type. In other examples, the Delta_payload_type may be configured as different open-loop power control parameters configured for different payload types (e.g., SR, HARQ-ACK, and CSI).

In some examples, the network may configure the power control offset (e.g., the power offset Delta_encoder, the power offset Delta_payload_size, and/or the power offset Delta_payload_type). In some examples, the power control offset may be set by and included within a standard or specification utilized by the UE in configuring the PUCCH transmit power. In some examples, the power control offset may include both the power offset Delta_payload_type and either the power offset Delta_encoder or the power offset Delta_payload_size.

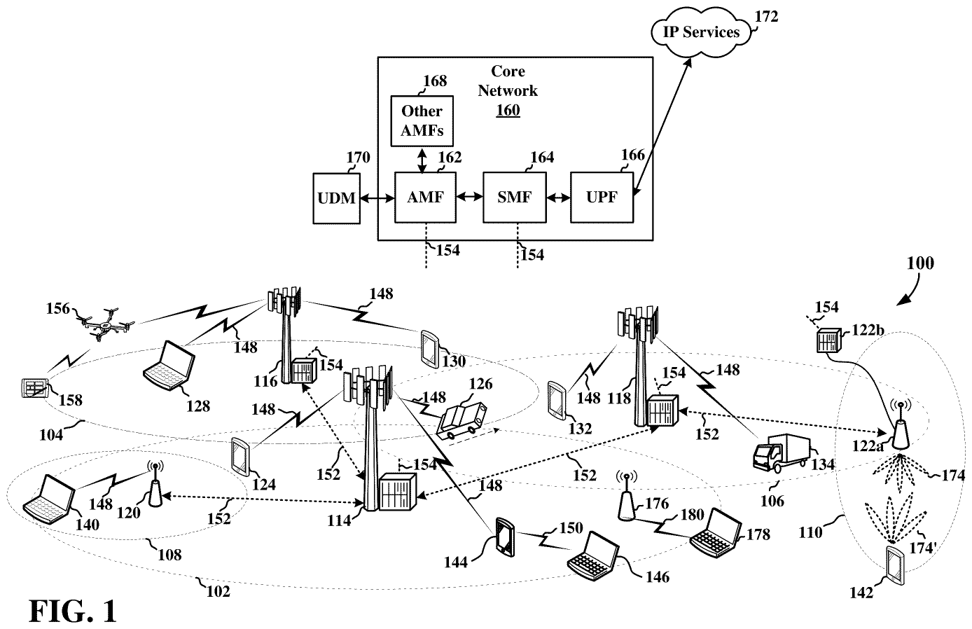

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

Deployment of communication systems, such as 5G new radio (NR) systems or 6G wireless systems, may be arranged in multiple manners with various components or constituent parts. In a 5G NR system or 6G system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

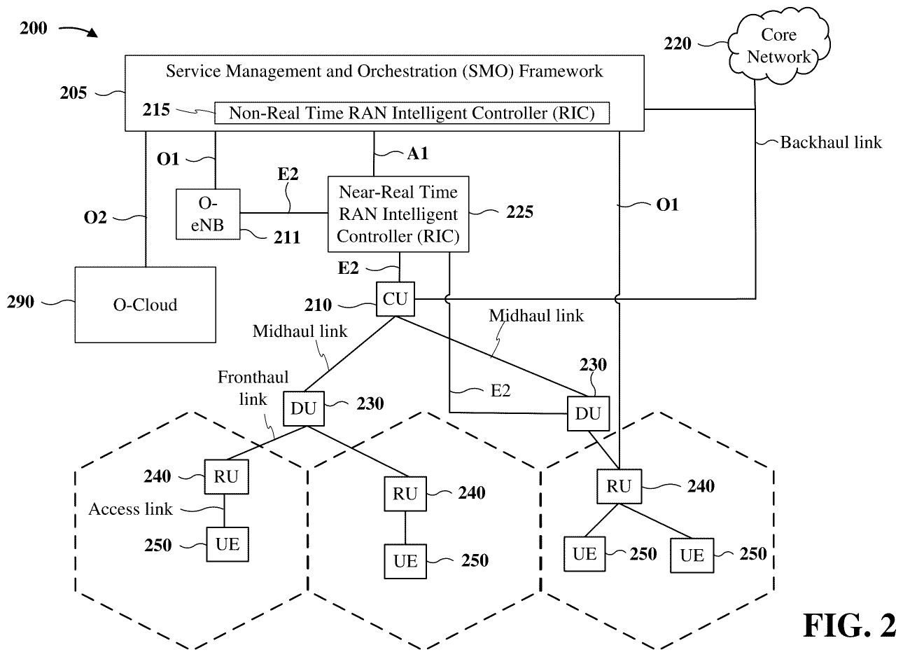

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 220 via respective midhaul links, such as an F1 interface. The DUs 220 may communicate with one or more radio units (RUS) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUS 210, the DUs 220, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 2rd Generation Partnership Project (2GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 220 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 220, RUs 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 220, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

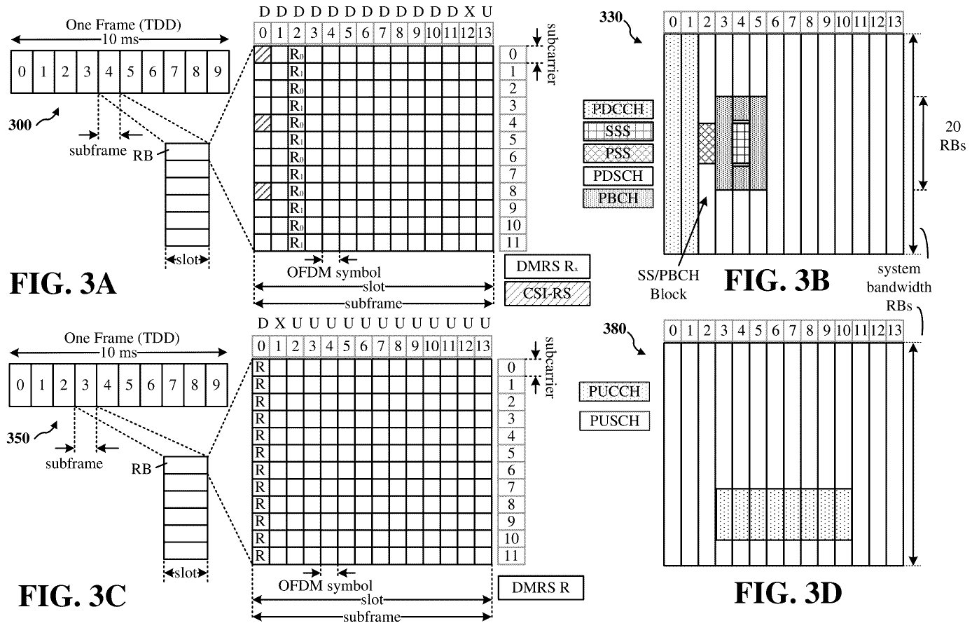

FIG. 3A is a diagram 300 illustrating an example of a first subframe within a 5G/NR frame structure. FIG. 3B is a diagram 330 illustrating an example of DL channels within a 5G/NR subframe. FIG. 3C is a diagram 350 illustrating an example of a second subframe within a 5G/NR frame structure. FIG. 3D is a diagram 380 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 3A, 3C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

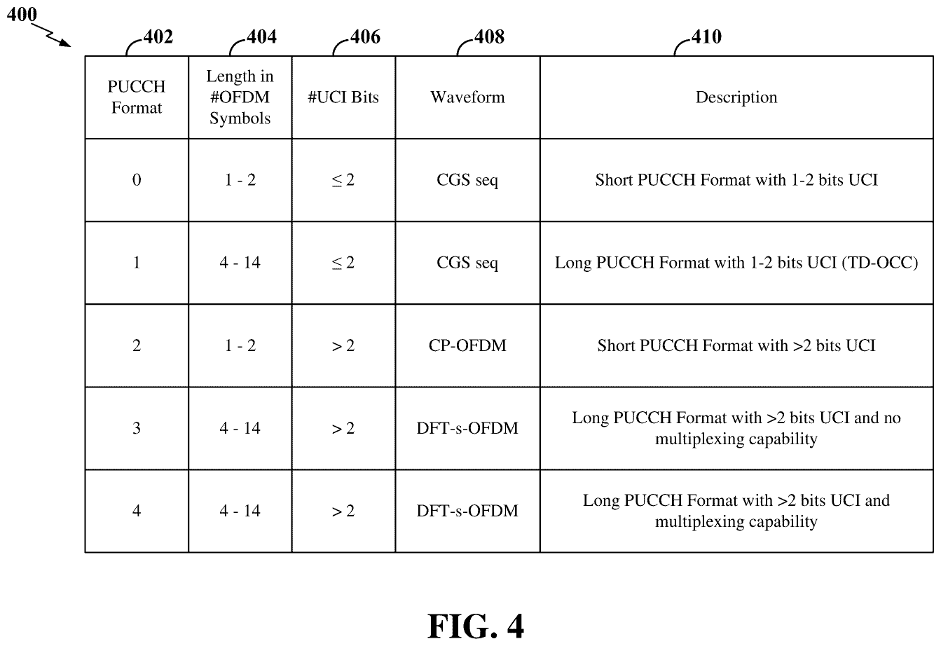

FIG. 4 is a diagram illustrating an example of physical uplink control channel (PUCCH) formats according to some aspects. The formats shown in FIG. 4 may correspond, for example, to the PUCCH formats specified in 3GPP TS 36.211, Release 15-17. FIG. 4 illustrates a table 400 including a plurality of PUCCH formats 402, a respective length 404 (in number of OFDM symbols) for each of the PUCCH formats 402, a respective number of uplink control information (UCI) bits 406 for each of the PUCCH formats 402, a respective waveform 408 for each of the PUCCH formats 402, and a respective description 410 for each of the PUCCH formats 402. In the example shown in FIG. 4, there are five PUCCH formats 402 (e.g., PUCCH formats 0, 1, 2, 3, and 4).

PUCCH formats 0 and 2 are short formats having a length 404 of one to two OFDM symbols. In PUCCH format 2, DMRS may further be frequency multiplexed with data subcarriers. PUCCH formats 1, 3, and 4 are long formats having a length 404 between four and fourteen OFDM symbols. PUCCH formats 1, 3, and 4 further include symbols having DMRS time-multiplexed with UCI symbols to achieve low peak-to-average-power-ratio (PAPR). PUCCH format 3 does not have a multiplexing capability, while PUCCH format 4 does have a multiplexing capability (e.g., multiplexing with other UEs).

In addition, PUCCH formats 0 and 1 have a small payload size 406 of one or two bits (e.g., ≤2 UCI bits), whereas PUCCH formats 2, 3, and 4 have a larger payload size 406 of more than two bits (e.g., >2 UCI bits). Each PUCCH format 402 further has a predetermined waveform 408 associated therewith. For example, PUCCH formats 0 and 1 are transmitted using a computer-generated sequence (CGS) waveform, PUCCH format 2 is transmitted using the CP-OFDM waveform, and PUCCH formats 3 and 4 are transmitted using the DFT-s-OFDM waveform.

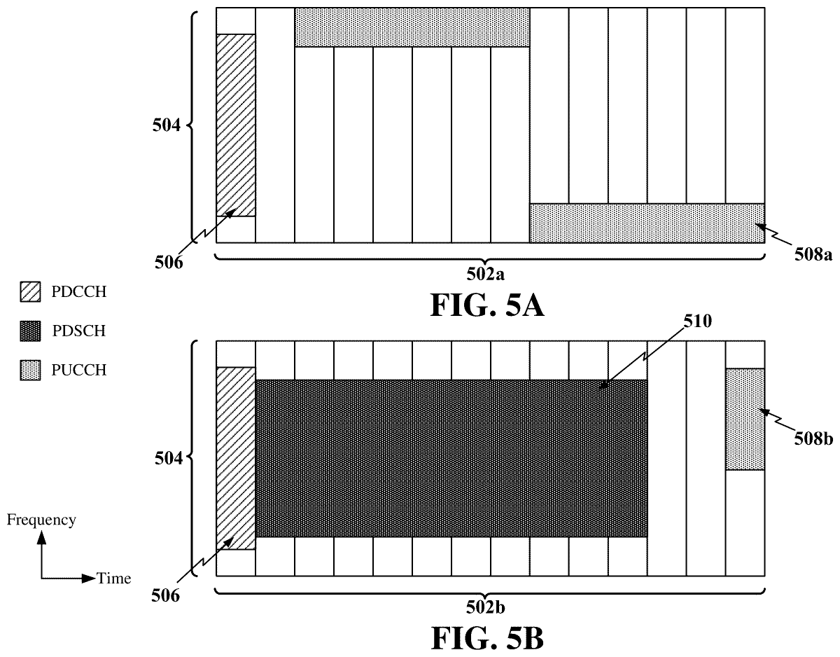

FIGS. 5A and 5B are diagrams illustrating examples of long PUCCH and short PUCCH according to some aspects. In the examples shown in FIGS. 5A and 5B, time is illustrated along the horizontal axis, while frequency is illustrated along the vertical axis. Each of FIGS. 5A and 5B illustrate a respective slot 502a and 502b, each including a plurality of symbols (e.g., fourteen OFDM or SC-FDM symbols) in the time domain. In addition, each of FIGS. 5A and 5B illustrate a respective BWP 504 including a subset of contiguous PRBs (e.g., each including a suitable number of subcarriers, such as twelve subcarriers) on a carrier in the frequency domain.

Each slot 502a and 502b includes a PDCCH 506 carrying DCI including downlink scheduling assignments and uplink scheduling grants. In some examples, the DCI may include scheduling information scheduling a PUSCH or PUCCH in the same or a subsequent slot. In other examples, the DCI may include scheduling information scheduling a PDSCH in the same or a subsequent slot. For example, as shown in FIG. 5B, the PDCCH 506 may schedule a PDSCH 510 transmitted within slot 502b. In some examples, a slot may not include DCI.

Each slot 502a and 502b may further include a PUCCH carrying UCI. Examples of UCI may include, but are not limited to, a scheduling request (SR), HARQ-ACK bits (e.g., HARQ feedback information), channel state feedback (CSF), or other suitable UCI. As shown in the table of FIG. 4, PUCCH Formats 1, 3, and 4 are long PUCCH formats that occupy four to fourteen symbols, and PUCCH formats 0 and 2 are short PUCCH formats that occupy one or two symbols. FIG. 5A illustrates a long PUCCH 508a, whereas FIG. 5B illustrates a short PUCCH 508b.

In the long PUCCH 508a, symbols with DMRS are time division multiplexed with UCI symbols to maintain low PAPR, whereas in the short PUCCH 508b, DMRS subcarriers are frequency division multiplexed with UCI subcarriers. Whether a long PUCCH 508a or a short PUCCH 508b is used may depend, for example, on the number of UCI bits to be carried in the PUCCH, whether multi-UE multiplexing on the same PUCCH resources is needed, and the channel conditions.

The resources (e.g., time-frequency resources, such as the number of PRBs, starting PRB, starting symbol, and number of symbols) to be used for the PUCCH, hereinafter referred to as PUCCH resources, may be predefined or dynamically configured. For example, the PUCCH resources may be predefined by 3GPP, TS 35.213, Release 15-17, Table 9.2.1-1. As another example, the PUCCH resources may be dynamically configured via an RRC message (e.g., PUCCH-Config). In either example, a UE may be configured with up to four PUCCH resource sets for UCI transmissions including HARQ-ACK bits, where each PUCCH resource set may be used to transmit UCI within a range of payload sizes. For example, one of the PUCCH resource sets may be used for a maximum of two UCI bits (e.g., two HARQ-ACK bits). Here, this PUCCH resource set may include a maximum of 32 PUCCH resources. Other PUCCH resource sets may be applicable for more than two UCI bits, each with a different range of number of UCI bits and each with a maximum of 5 PUCCH resources. Each PUCCH resource set may have a PUCCH format (e.g., PUCCH format 0-4) associated therewith. A UE can select one of the configured PUCCH resource sets based on the UCI payload size. The UE can then further select a specific single PUCCH resource within the selected PUCCH resource set. For example, DCI may include a PUCCH resource indicator (PRI) identifying the specific PUCCH resource to use for a PUCCH transmission. The PRI may be, for example, a 3-bit field within DCI Format 1_0 or DCI Format 1_1. In some examples, the PUCCH format and time domain resource allocation may be determined by the PUCCH resource configuration, but the frequency domain resource allocation may not be explicitly specified. In this example, the frequency domain resource allocation may be determined by the DCI and the control channel element (CCE) location of the PDCCH carrying the DCI (e.g., based on the index of the first CCE of the PDCCH and the number of CCEs in a control resource set (CORESET) of the PDCCH).

Power control of PUCCH transmissions may be implemented using, for example, the following PUCCH power control equation:

$${P}_{PUCCH , b , f , c} ( i , {q}_{u} , {q}_{d} , l ) = min \{ \begin{matrix}{P}_{CMAX , f , c} ( i ) \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} )\end{matrix} + {Δ}_{F \_ PUCCH} ( F ) + {Δ}_{TF , b , f , c} ( i ) + {g}_{b , f , c} ( i , l ) . \qquad ( Equation 1 )$$

In the PUCCH power control equation (Equation 1), P_{CMAX,f,c}(i) represents the maximum power allowed on the carrier (f) and cell (c) for the PUCCH index (i). In addition, the term P_{O}_{_{PUCCH,b,f,c}}(qᵤ) is the open-loop power control parameter for the BWP index (b), carrier (f) and cell (c) for the uplink quasi co-location (QCL) index (qᵤ) (e.g., the DL/UL reference signal quasi co-located with the PUCCH transmission). The open-loop power control parameter may be set based on the target performance block error rate (BER) and may be configured by the network entity (e.g., gNB). The term g_{b,f,c}(i, l) is the closed-loop power control parameter for the BWP index (b), carrier (f) and cell (c) for the PUCCH index (i) and the power loop control index (I). The closed-loop power control parameter for the BWP index (b), carrier (f) and cell (c) for the PUCCH index (i) and the power loop control index (I) may be configured by the network entity and contained, for example, in DCI. In some examples, the closed-loop power control parameter may be accumulated over multiple slots.

In the term

$$10 {log}_{10} ( {2}^{μ} \cdot {M}_{RB , b , f , c}^{PUCCH} ( i ) ) ,$$

μ corresponds to the numerology (scaling factor) and

$${M}_{RB , b , f , c}^{PUCCH} ( i )$$

corresponds to the bandwidth of the PUCCH transmission (e.g., number of resource blocks (RBs)) on the BWP index (b), carrier (f), and cell (c) allocated for the PUCCH index (i). The term PL_{b,f,c}(q_{d}) represents a path loss compensation parameter based on the downlink path loss measured by the UE on the BWP index (b), carrier (f), and cell (c) for the downlink QCL index (q_{d}). Thus, the path loss compensation parameter is determined by the UE and varies based on the measured downlink path loss.

The term+Δ_{F_PUCCH}(F) is a PUCCH format-specific offset used to provide a respective power offset for different PUCCH transmission formats (e.g., PUCCH Format 0, 1, 2, 3, or 4). For example, the parameter+Δ_{F_PUCCH}(F) may have a value of deltaF-PUCCH-f0 for PUCCH format 0, deltaF-PUCCH-f1 for PUCCH format 1, deltaF-PUCCH-f2 for PUCCH format 2, deltaF-PUCCH-f3 for PUCCH format 3, and deltaF-PUCCH-f4 for PUCCH format 4. The PUCCH format-specific offset may be configured by the network entity and set based on the PUCCH format (F).

The term Δ_{TF,b,f,c}(i) is a PUCCH payload size dependent offset (power adjustment parameter) for the BWP index (b), carrier (f), and cell (c) allocated for the PUCCH index (i), which is configured by the network entity based on the PUCCH payload size, or equivalently, based on the channel encoder type. For example, UCI bits are encoded with a Reed Muller encoder when the #UCI bits<=11, whereas UCI bits are encoded with a polar encoder when the #UCI bits>11. Different encoders may yield different coding gains, and therefore require different transmit power. The different transmit powers may be achieved using different payload size dependent offsets.

For example, for a PUCCH transmission using PUCCH format 2, PUCCH format 3, or PUCCH format 4 and for a payload size with a number of UCI bits less than or equal to eleven (e.g., #UCI bits<=11) encoded with a Reed Muller encoder, the payload size dependent offset may be set as follows:

$$( Equation 2 )$$

$${Δ}_{TF , b , f , c} ( i ) = 10 {log}_{10} ( {K}_{1} \cdot ( {n}_{HARQ - ACK} ( i ) + {O}_{SR} ( i ) + {O}_{CSI} ( i ) ) / {N}_{RE} ( i ) ) .$$

In Equation 2 above, K₁ is a constant factor (e.g., K₁=6), n_{HARQ-ACK}(i) is the number of HARQ-ACK (e.g., acknowledgement) bits in the PUCCH transmission (PUCCH index (i)), O_{SR}(i) is the number of scheduling request bits in the PUCCH transmission, O_{CSI}(i) is the number of channel state information bits in the PUCCH transmission, and N_{RE}(i) is the number of resource elements allocated for the PUCCH transmission.

For a PUCCH transmission using PUCCH format 2, PUCCH format 3, or PUCCH format 4 and for a payload size with a number of UCI bits more than eleven (e.g., #UCI bits>11) encoded with a polar encoder, the payload size dependent offset may be set as follows:

$${Δ}_{TF , b , f , c} ( i ) = 10 {log}_{10} ( {2}^{{K}_{2} \cdot BPRE ( i )} - 1 ) , \qquad ( Equation 3 )$$

$$where$$

$$BPRE ( i ) + {O}_{SR} ( i ) + {O}_{CSI} ( i ) + {O}_{CRC} ( i ) ) / {N}_{RE} ( i ) ) . \qquad ( Equation 4 )$$

In Equations 3 and 4 above, K₂ is a constant factor (e.g., K₂=2.4), O_{ACK}(i) is the number of HARQ-ACK (e.g., acknowledgement) bits in the PUCCH transmission (PUCCH index (i)), O_{SR}(i) is the number of scheduling request bits in the PUCCH transmission, O_{CSI}(i) is the number of channel state information bits in the PUCCH transmission, O_{CRC}(i) is the number of cyclic redundancy check (CRC) bits in the PUCCH transmission, and N_{RE}(i) is the number of resource elements allocated for the PUCCH transmission. For PUCCH transmissions with greater than eleven ACK-NACK/SR/CSI bits, CRC is generated, thus increasing the total number of UCI bits in the PUCCH transmission. For example, for a number of UCI bits between 11 and 19, the number of added CRC bits is six, whereas for a number of UCI bits greater than 19 (e.g., #UCI bits>19), the number of added CRC bits is eleven.

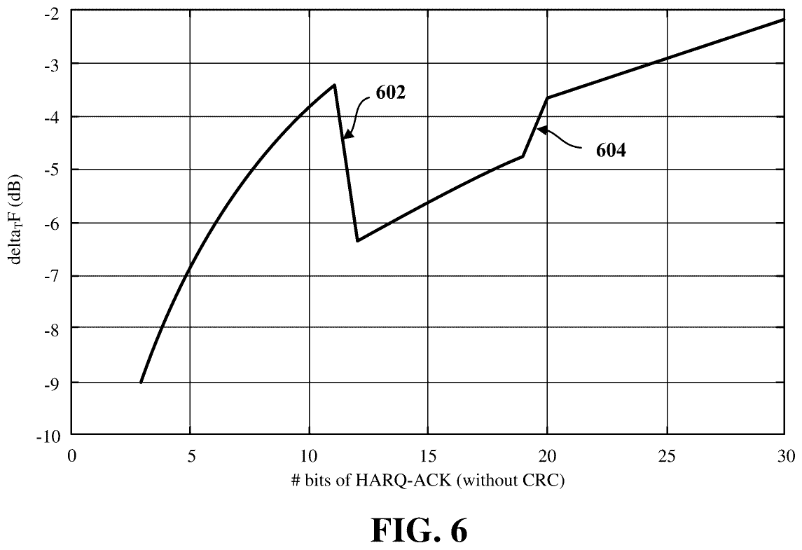

FIG. 6 is a diagram illustrating a power profile of a payload size dependent offset based on the payload size of a PUCCH according to some aspects. In the example shown in FIG. 6, the payload size dependent offset is plotted for increasing number of HARQ-ACK bits without other types of UCI (e.g., without SR or CSI), without CRC, and for a number of REs corresponding to one RB. As shown in FIG. 6, the power (in decibels (dB)) of the payload size dependent offset (delta_{T}F) increases in accordance with the logarithmic function of Equation 2 above until the number of CRC bits reaches 11 bits. In the transition from 11 UCI bits to 12 UCI bits at 602, there is a large dip (e.g., 3 dB) due to the different equations (e.g., Equations 2 and 3) used for #UCI bits<=11 bits and #UCI bits>11, respectively. Although the difference in encoders (Reed Muller and polar) used between 11 bits and 12 bits may produce some coding gain difference, the large difference shown in FIG. 6 may unnecessarily lower the power, which may result in a PUCCH transmit failure. FIG. 6 further illustrates a jump at 604 in the power of the payload size dependent offset between 19 UCI bits and 20 bits, which is expected due to a CRC jump from 6 CRC bits to 11 CRC bits based on the polar encoder design.

As shown in Equation 1 above, there is no power control offset/adjustment term based on the type of PUCCH payload (e.g., SR, HARQ-ACK, and/or CSI). However, the performance requirements (e.g., error rate (BER)) may be different for different payload types. For example, the BLER requirement for CSI is 10⁻² BLER, whereas the HARQ-ACK requirements may be 10⁻² BLER for incorrect detection of HARQ-ACK (e.g., the network entity detects an ACK/NACK, but the UE does not send an ACK/NACK), 10⁻² BLER for failed detection of HARQ-ACK (e.g., the UE transmits an ACK/NACK, but the network entity does not detect the ACK/NACK), and 10⁻³ BLER for false detection of HARQ-QCK type (e.g., the UE sends a NACK, but the network entity detects an ACK). Since the performance requirement of CSI (10⁻² BLER) is lower than the performance requirement for some HARQ-ACK (10⁻³ BLER), the different performance requirements may require different transmit powers to ensure those performance requirements are met. For example, the UE may use a higher transmit power for HARQ-ACK than CSI or other types of UCI.

Various aspects are directed to a power control offset based on at least one of a number of UCI bits, an encoder type, or a payload type of the PUCCH. For example, a power offset Delta_encoder or power offset Delta_payload_size may be added to the PUCCH power control equation shown in Equation 1 or to the payload size dependent offset shown in Equation 3 when the payload size is greater than eleven UCI bits to smooth the transmit power in the transition between eleven to twelve UCI bits. For example, the Delta_encoder or Delta_payload_size may be set to 0 dB for a Reed Muller encoder or number of UCI bits less than or equal to eleven, and 3 dB for a polar encoder or a number of UCI bits greater than eleven. As another example, a PUCCH payload type dependent power offset (Delta_payload_type) may be added to the PUCCH power control equation shown in FIG. 1 or different open-loop power control parameters (Po_PUCCH values) may be configured for different payload types (e.g., SR, HARQ-ACK, and CSI). For example, the Delta_payload_type may be set to 2 dB for CSI or SR and 6 dB for HARQ-ACK. In some examples, the network (e.g., a network entity, such as a gNB, aggregated base station, or disaggregated base station) may configure the power control offset (e.g., the power offset Delta_encoder, the power offset Delta_payload_size, or the power offset Delta_payload_type). In some examples, the power control offset may be set by and included within a standard or specification utilized by the UE to configure the PUCCH transmit power. In some examples, the power control offset may include both the power offset Delta_payload_type and either the power offset Delta_encoder or the power offset Delta_payload_size.

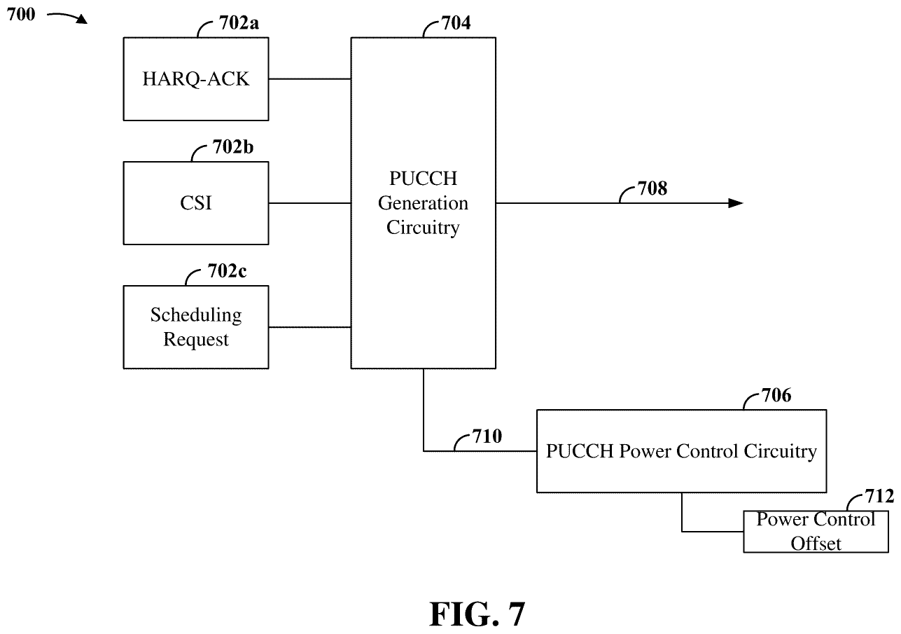

FIG. 7 is a diagram illustrating an example of a UE 700 configured to generate a PUCCH at a particular transmit power according to some aspects. The UE 700 includes PUCCH generation circuitry 704 and PUCCH power control circuitry 706. The PUCCH generation circuitry 704 is configured to generate a PUCCH 708 including a payload containing one or more types of UCI. For example, the PUCCH 708 may be generated to include one or more of HARQ-ACK bits 702a, CSI bits 702b, and/or Scheduling Request (SR) bits 702c.

The PUCCH power control circuitry 706 is configured to configure a transmit power 710 of the PUCCH 708. The PUCCH power control circuitry 706 may configure the transmit power 710 using, for example, Equation 1 shown above modified to include an additional power control offset 712 based on at least one of a payload type, a number of uplink control information (UCI) bits, or an encoder type (e.g., power offset Delta_encoder, power offset Delta_payload_size, or power offset Delta_payload_type). In some examples, the additional power control offset term 712 may correspond to either the power offset Delta_encoder or the power offset Delta_payload_size, represented generally as Δ_{PE,b,f,c}(i), and added to Equation 1 as follows.

$${P}_{PUCCH , b , f , c} ( i , {q}_{u} , {q}_{d} , l ) = min \{ \begin{matrix}{P}_{CMAX , f , c} ( i ) \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} )\end{matrix} + {Δ}_{F \_ PUCCH} ( F ) + {Δ}_{TF , b , f , c} ( i ) + {g}_{b , f , c} ( i , l ) + {Δ}_{PE , b , f , c} ( i ) . \qquad ( Equation 5 )$$

In some examples, the additional power control offset 712 may correspond to the power offset Delta_payload_type, represented as Δ_{PT,b,f,c}(i), and added to Equation 1 as follows:

$${P}_{PUCCH , b , f , c} ( i , {q}_{u} , {q}_{d} , l ) = min \{ \begin{matrix}{P}_{CMAX , f , c} ( i ) \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} )\end{matrix} + {Δ}_{F \_ PUCCH} ( F ) + {Δ}_{TF , b , f , c} ( i ) + {g}_{b , f , c} ( i , l ) + {Δ}_{PT , b , f , c} ( i ) . \qquad ( Equation 6 )$$

In some examples, the power offset Delta_payload_type (Δ_{PT,b,f,c}(i)) may be set to a first value for the scheduling request payload type (e.g., Δ_{PT,b,f,c}(i, SR)), a second value for the HARQ-ACK payload type (e.g., Δ_{PT,b,f,c}(i, HA)), and a third value for the channel state information (CSI) payload type (e.g., Δ_{PT,b,f,c}(i, CSI)). In examples in which the PUCCH payload includes multiple payload types, the largest value may be used. For example, if the PUCCH payload includes both HARQ-ACK bits 702a and CSI bits 702b, and the power offset Delta_payload_type value for HARQ-ACK is higher than the power offset Delta_payload_type value for CSI, the PUCCH power control circuitry 706 may select the power offset Delta_payload_type value associated with HARQ-ACK (e.g., Δ_{PT,b,f,c}(i, HA)) for inclusion in Equation 6.

In some examples, the additional power control offset 712 may include both the power offset Delta_payload_type, represented as Δ_{PT,b,f,c}(i), and either the power offset Delta_encoder or the power offset Delta_payload_size, represented generally as Δ_{PE,b,f,c}(i), and each added to Equation 1 as follows:

$${P}_{PUCCH , b , f , c} ( i , {q}_{u} , {q}_{d} , l ) = min \{ \begin{matrix}{P}_{CMAX , f , c} ( i ) \\ {P}_{O \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} )\end{matrix} + {Δ}_{F \_ PUCCH} ( F ) + {Δ}_{TF , b , f , c} ( i ) + {g}_{b , f , c} ( i , l ) + {Δ}_{PT , b , f , c} ( i ) + {Δ}_{PE , b , f , c} ( i ) . \qquad ( Equation 7 )$$

In other examples, the PUCCH power control circuitry 706 may modify Equation 3 above to include the additional power control offset 712 (e.g., power offset Delta_encoder or power offset Delta_payload_size). For example, the additional power control offset 712 may be represented generally as Δ_{PE,b,f,c}(i) and added to Equation 3 as follows:

$${Δ}_{TF , b , f , c} ( i ) = 10 {log}_{10} ( {2}^{{K}_{2} \cdot BPRE ( i )} - 1 + {Δ}_{PE , b , f , c} ( i ) ) . \qquad ( Equation 8 )$$

In this example, the power offset Delta_payload_size may also be added to Equation 1 as shown in Equation 6 above to adjust the transmit power for both the payload size/encoder and the payload type.

In some examples, instead of adding a new term to Equation 1, the power offset Delta_payload_size may be represented by different values for the open-loop power control parameter P_{O_PUCCH,b,f,c}(qᵤ) shown in Equation 1. For example, a first open-loop power control parameter P_{O_PUCCH,b,f,c}(qᵤ, SR) may be configured for the scheduling request payload type, a second open-loop power control parameter P_{O_PUCCH,b,f,c}(qᵤ, HA) may be configured for the HARQ-ACK payload type, and third open-loop power control parameter P_{O_PUCCH,b,f,c}(qᵤ, CSI) may be configured for the channel state information (CSI) payload type. In examples in which the PUCCH payload includes multiple payload types, the largest open-loop power control parameter value may be used.

In some examples, the additional power control offset 712 may be configured by the network (e.g., a network entity, such as a gNB, aggregated base station, or disaggregated base station) and sent to the UE 700. The PUCCH power control circuitry 706 may then use the additional power control offset 712 in configuring the transmit power 710 for the PUCCH 708.

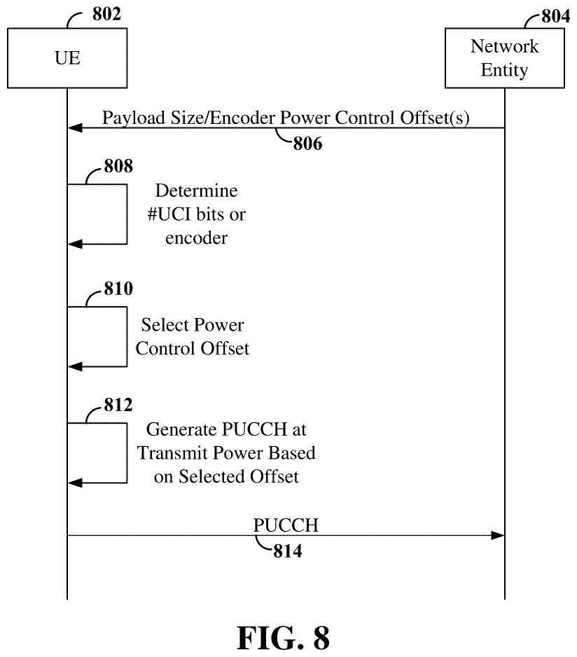

FIG. 8 is a signaling diagram illustrating exemplary signaling between a UE 802 and a network entity 804 for configuring a transmit power of a PUCCH according to some aspects. The UE 802 may correspond to any of the UEs or other wireless communication devices shown in any of FIGS. 1, 2, and/or 7. The network entity 804 may correspond to any of the base stations or other network entities shown in FIGS. 1 and/or 2. For example, the network entity 804 may correspond to an aggregated base station, an RU, a DU, a CU, a TRP, an IAB node, or other network device.

At 806, the network entity 804 may send a power control offset based on a payload size (e.g., number of UCI bits) or an encoder type of a PUCCH to the UE 802. For example, the power control offset may be configured with both a first value when the number of UCI bits is less than or equal to eleven and/or the encoder type is a Reed Muller encoder, and a second value when the number of UCI bits is greater than eleven and/or the encoder type is a polar encoder. In some examples, the first value is less than the second value. In some examples, the power control offset may be configured with only the second value, and as such, is not applicable to PUCCHs generated with a number of UCI bits less than or equal to eleven and/or a Reed Muller encoder.

At 808, the UE 802 may determine a number of UCI bits to be included in a PUCCH and/or an encoder type of an encoder to be used to generate the PUCCH. For example, the UE 802 may determine that the number of UCI bits is less than or equal to eleven and/or that the encoder type is a Reed Muller encoder. In other examples, the UE 802 may determine that the number of UCI bits is greater than eleven and/or that the encoder type is a polar encoder.

At 810, the UE 802 may select the power control offset to be applied to the transmit power of the PUCCH. For example, the UE 802 may select a first value (e.g., 0 dB) for the power control offset when the number of UCI bits is less than or equal to eleven and/or the encoder type is a Reed Muller encoder, and a second value (e.g., 3 dB) for the power control offset when the number of UCI bits is greater than eleven and/or the encoder type is a polar encoder. Here again, the first value may be less than the second value. In other examples, the UE 802 may select no power control offset to be applied to the transmit power when the number of UCI bits is less than or equal to eleven and/or the encoder type is a Reed Muller encoder, and the second value (e.g., 3 dB) for the power control offset when the number of UCI bits is greater than eleven and/or the encoder type is a polar encoder.

At 812, the UE 802 may generate the PUCCH at a desired transmit power based on the selected power control offset. For example, the UE 802 may use both Equation 3 and Equation 5 above or both Equation 1 and Equation 8 above to generate the PUCCH at the desired transmit power. In examples in which no power control offset is applied (e.g., the number of UCI bits is less than or equal to eleven and/or the encoder type is a Reed Muller encoder), the UE 802 may simply use Equation 1 and Equation 2 above to generate the PUCCH at the desired transmit power. At 814, the UE 802 may transmit the PUCCH at the desired transmit power to the network entity 804.

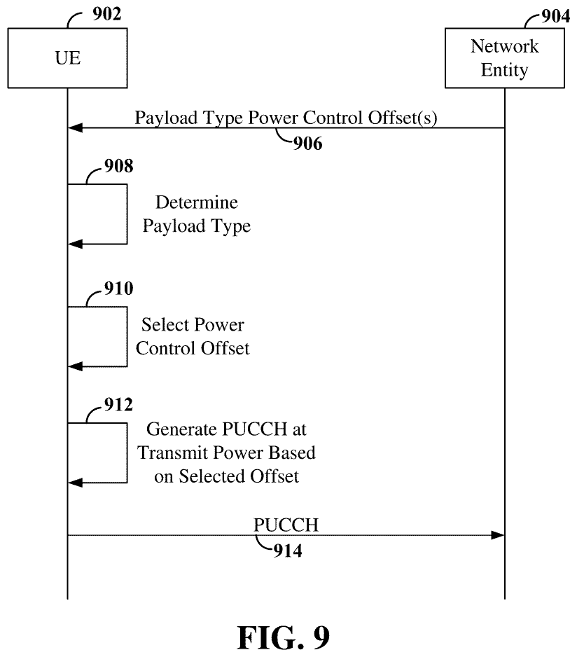

FIG. 9 is another signaling diagram illustrating exemplary signaling between a UE 902 and a network entity 904 for configuring a transmit power of a PUCCH according to some aspects. The UE 902 may correspond to any of the UEs or other wireless communication devices shown in any of FIGS. 1, 2, and/or 7. The network entity 904 may correspond to any of the base stations or other network entities shown in FIGS. 1 and/or 2. For example, the network entity 904 may correspond to an aggregated base station, an RU, a DU, a CU, a TRP, an IAB node, or other network device.

At 906, the network entity 804 may send a power control offset based on a payload type (e.g., SR, HARQ-ACK, or CSI) of a PUCCH to the UE 902. For example, the power control offset may be configured with a first value for the SR payload type, a second value for the HARQ-ACK payload type, and a third value for the CSI payload type. In some examples, the second value is greater than the first or third values. In some examples, the power control offset may be configured with only the second value, and as such, is not applicable to PUCCHs generated with SR or CSI payload types. In some examples, the power control offset is configured as different open-loop power control parameter values. In other examples, the power control offset is configured as different power control offset values that may be added to Equation 1 (e.g., as shown in Equation 6).

At 908, the UE 902 may determine the payload type of a PUCCH to be generated. For example, the payload type may include one or more of SR bits, HARQ-ACK bits, and/or CSI bits. At 910, the UE 902 may select the power control offset to be applied to the transmit power of the PUCCH. For example, the UE 902 may select the first value (e.g., 2 dB) for the power control offset when the payload type is SR bits, the second value (e.g., 6 dB) for the power control offset when the payload type is HARQ-ACK bits, and the third value (e.g., 3 dB) for the power control offset when the payload type is CSI bits. In examples in which there are multiple payload types included in the same PUCCH, the UE 902 may select the largest value for the power control offset based on the payload types included in the PUCCH. For example, if the PUCCH includes SR and CSI and the CSI has a higher/larger power control offset value, the UE 902 may select the CSI power control offset value. As another example, if the PUCCH includes CSI and HARQ-ACK and the HARQ-ACK has a higher/larger power control offset value, the UE 902 may select the HARQ-ACK power control offset value. In other examples, the UE 802 may select no power control offset to be applied to the transmit power if the PUCCH includes a payload type for which no power control offset is configured. For example, if there is no power control offset configured for SR, and the PUCCH includes only SR UCI bits, the UE 902 may not apply any power control offset (or open-loop power control parameter specific to payload type) to the transmit power.

At 912, the UE 902 may generate the PUCCH at a desired transmit power based on the selected power control offset. For example, the UE 902 may use Equation 1 above with a modified open-loop power control parameter for the payload type(s) included in the PUCCH or Equation 6 above to generate the PUCCH at the desired transmit power. In examples in which no power control offset is applied (e.g., there is no power control offset configured for the payload type), the UE 902 may simply use Equation 1 above to generate the PUCCH at the desired transmit power. At 914, the UE 902 may transmit the PUCCH at the desired transmit power to the network entity 904.

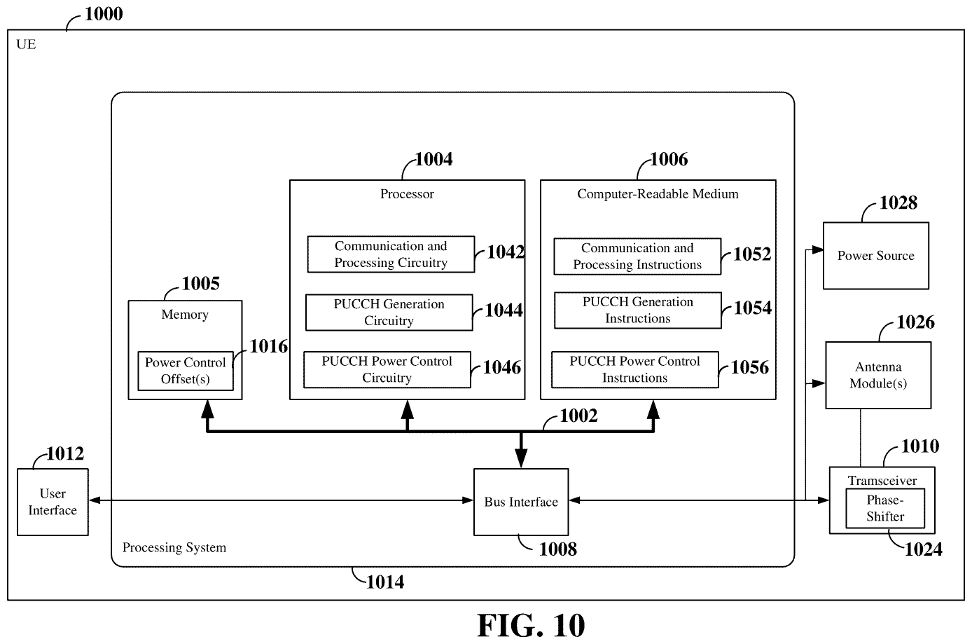

FIG. 10 is a block diagram illustrating an example of a hardware implementation of a user equipment (UE) 1000 employing a processing system 1014 according to some aspects. For example, the UE 1000 may correspond to any of the UEs shown and described above in reference to FIGS. 1, 2, 7, 8, and/or 9.

In accordance with various aspects of the disclosure, an element, or any portion of an element, or any combination of elements may be implemented with a processing system 1014 that includes one or more processors, such as processor 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1000 may be configured to perform any one or more of the functions described herein. That is, the processor 1004, as utilized in the UE 1000, may be used to implement any one or more of the methods or processes described and illustrated, for example, in FIGS. 8, 9, and/or 11.

The processor 1004 may in some instances be implemented via a baseband or modem chip and in other implementations, the processor 1004 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits, including one or more processors (represented generally by the processor 1004), one or more memories (represented generally by the memory 1005), and one or more computer-readable media (represented generally by the computer-readable medium 1006). In some examples, the computer-readable media 1006 may be included within or part of one or more of the memories 1005. The bus 1002 may also link various other circuits such as timing sources, peripherals, voltage regulators, and power management circuits, which are well known in the art, and therefore, are not described any further.

A bus interface 1008 provides an interface between the bus 1002, one or more transceivers 1010, one or more antenna modules (e.g., one or more antenna arrays or panels) 1026, and a power source 1028 (e.g., a battery). The transceiver 1010 and antenna array(s) 1026 provides a means for communicating with various other apparatus over a transmission medium (e.g., air interface). The bus interface 1008 further provides an interface between the bus 1002 and a user interface 1012 (e.g., keypad, display, touch screen, speaker, microphone, control features, etc.). Of course, such a user interface 1012 may be omitted in some examples.

The computer-readable medium 1006 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1006 may reside in the processing system 1014, external to the processing system 1014, or distributed across multiple entities including the processing system 1014. The computer-readable medium 1006 may be embodied in a computer program product. By way of example, a computer program product may include a computer-readable medium in packaging materials. In some examples, the computer-readable medium 1006 may be part of the memory 1005. Those skilled in the art will recognize how best to implement the described functionality presented throughout this disclosure depending on the particular application and the overall design constraints imposed on the overall system. In some examples, the computer-readable medium 1006 may be implemented on an article of manufacture, which may further include one or more other elements or circuits, such as the processor 1004 and/or memory 1005.

The computer-readable medium 1006 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1004, may be responsible for managing the bus 1002 and general processing, including the execution of the software (e.g., instructions or computer-executable code) stored on the computer-readable medium 1006. The software, when executed by the processor 1004, causes the processing system 1014 to perform the various processes and functions described herein for any particular apparatus. The computer-readable medium 1006 and/or the memory 1005 may also be used for storing data that may be manipulated by the processor 1004 when executing software. For example, the memory 1005 may store one or more power control offsets 1016.

In some aspects of the disclosure, the processor 1004 may include circuitry configured for various functions. For example, the processor 1004 may include communication and processing circuitry 1042 configured to communicate with one or more UEs and/or one or more network entities. In some examples, the communication and processing circuitry 1042 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1042 may include one or more transmit/receive chains.

In some implementations where the communication involves receiving information, the communication and processing circuitry 1042 may obtain information from a component of the UE 1000 (e.g., from the transceiver 1010 that receives the information via radio frequency signaling or some other type of signaling suitable for the applicable communication medium), process (e.g., decode) the information, and output the processed information. For example, the communication and processing circuitry 1042 may output the information to another component of the processor 1004, to the memory 1005, or to the bus interface 1008. In some examples, the communication and processing circuitry 1042 may receive one or more of signals, messages, other information, or any combination thereof. In some examples, the communication and processing circuitry 1042 may receive information via one or more channels. In some examples, the communication and processing circuitry 1042 may include functionality for a means for receiving. In some examples, the communication and processing circuitry 1042 may include functionality for a means for processing, including a means for demodulating, a means for decoding, etc.

In some implementations where the communication involves sending (e.g., transmitting) information, the communication and processing circuitry 1042 may obtain information (e.g., from another component of the processor 1004, the memory 1005, or the bus interface 1008), process (e.g., modulate, encode, etc.) the information, and output the processed information. For example, the communication and processing circuitry 1042 may output the information to the transceiver 1010 (e.g., that transmits the information via radio frequency signaling or some other type of signaling suitable for the applicable communication medium). In some examples, the communication and processing circuitry 1042 may send one or more of signals, messages, other information, or any combination thereof. In some examples, the communication and processing circuitry 1042 may send information via one or more channels. In some examples, the communication and processing circuitry 1042 may include functionality for a means for sending (e.g., a means for transmitting). In some examples, the communication and processing circuitry 1042 may include functionality for a means for generating, including a means for modulating, a means for encoding, etc.

In some examples, the communication and processing circuitry 1042 may be configured to receive and process downlink beamformed signals at a mmWave frequency or a sub-6 GHz frequency via the transceiver 1010 and the antenna module(s) 1026 (e.g., using a phase-shifter 1024). In addition, the communication and processing circuitry 1042 may be configured to generate and transmit uplink beamformed signals at a mmWave frequency or a sub-6 GHz frequency via the transceiver 1010 and antenna module(s) 1026 (e.g., using the phase-shifter 1024).

In some examples, the communication and processing circuitry 1042 may be configured to communicate with a network entity (e.g., aggregated or disaggregated base station gNB, TRP(s), etc.) to transmit a PUCCH to the network entity at a transmit power. In some examples, the communication and processing circuitry 1042 may be configured to communicate with the network entity to receive one or more power control offsets 1016 and to store the power control offset(s) 1016 within, for example, the memory 1005. For example, the power control offset(s) 1016 may be fixed amounts configured by the network entity. The communication and processing circuitry 1042 may further be configured to execute communication and processing software 1052 stored on the computer-readable medium 1006 to implement one or more functions described herein.

The processor 1004 may further include PUCCH generation circuitry 1044, configured to generate a PUCCH for transmission to the network entity via the communication and processing circuitry 1042. For example, the PUCCH generation circuitry 1044 may correspond to the PUCCH generation circuitry 704 shown in FIG. 7. The PUCCH generation circuitry 1044 may be configured, for example, to generate a PUCCH containing a number of uplink control information (UCI) bits corresponding to one or more of a scheduling request (SR), HARQ-ACK, and/or CSI. The PUCCH generation circuitry 1044 may further be configured to execute PUCCH generation instructions (software) 1054 stored on the computer-readable medium 1006 to implement one or more functions described herein.

The processor 1004 may further include PUCCH power control circuitry 1046, configured to configure a transmit power of the PUCCH. For example, the transmit power may include a payload size dependent offset and an additional power control offset 1016 based on at least one of a payload type, a number of UCI bits, or an encoder type. In some examples, the additional power control offset is based on the number of UCI bits or the encoder type. For example, the additional power control offset may be added to a power control equation including the payload size dependent offset and the PUCCH power control circuitry 1046 may be configured to calculate the transmit power using the power control equation. In some examples, the additional power control offset is added to the payload size dependent offset within the power control equation.

In some examples, the additional power control offset is a fixed offset configured by the network entity. For example, the fixed offset may be set to a first value in response to the number of uplink bits being less than or equal to a threshold number of bits (e.g., 11 UCI bits) and a second value in response to the number of uplink bits being greater than the threshold number of bits (e.g., 11 UCI bits). Here, the second value is greater than the first value. In some examples, the fixed offset is set to a first value in response to the encoder type being a first encoder type and a second value in response to the encoder type being a second encoder type. For example, the first encoder type can include a Reed Muller encoder and the second encoder type can include a polar encoder. Here, the second value is again greater than the first value.

In some examples, the additional power control offset is based on the payload type, where the payload type includes at least one a scheduling request, channel state information, or acknowledgement information (e.g., HARQ-ACK information). In some examples, the additional power control offset is added to a power control equation including the payload size dependent offset and the PUCCH power control circuitry 1046 may be configured to calculate the transmit power using the power control equation. In some examples, the additional power control offset is a fixed offset configured by the network entity. In some examples, the power control equation includes an open loop power control parameter, a closed loop power control parameter, an uplink PUCCH format offset, a path loss parameter, and a bandwidth parameter. In some examples, the open loop power control parameter includes the additional power control offset and is configured by the network entity. The PUCCH power control circuitry 1046 may further be configured to execute PUCCH power control instructions (software) 1056 stored on the computer-readable medium 1006 to implement one or more functions described herein.

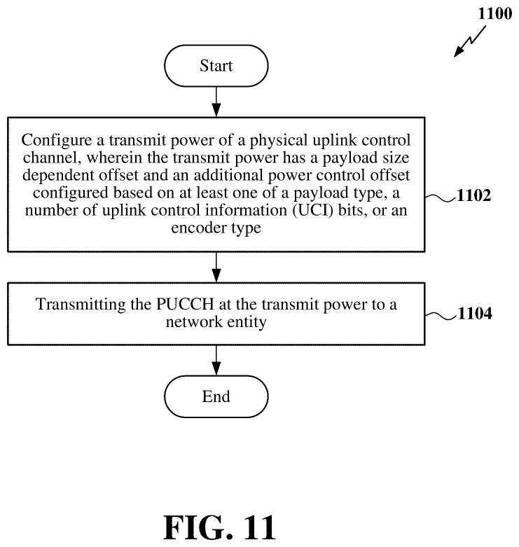

FIG. 11 is a flow chart illustrating an exemplary process 1100 for a UE to configure a transmit power of a PUCCH according to some aspects. As described below, some or all illustrated features may be omitted in a particular implementation within the scope of the present disclosure, and some illustrated features may not be required for implementation of all embodiments. In some examples, the process 1100 may be carried out by the UE 1000 illustrated in FIG. 10. In some examples, the process 1100 may be carried out by any suitable apparatus or means for carrying out the functions or algorithm described below.

At block 1102, the UE may configure a transmit power of a physical uplink control channel (PUCCH), where the transmit power includes a payload size dependent offset and an additional power control offset based on at least one of a payload type, a number of uplink control information (UCI) bits, or an encoder type. For example, the PUCCH power control circuitry 1046, shown and described above in connection with FIG. 10, may provide a means to configure the transmit power of the PUCCH.

In some examples, the additional power control offset is based on the number of UCI bits or the encoder type. In some examples, the additional power control offset is added to a power control equation including the payload size dependent offset and the UE may calculate the transmit power using the power control equation. In some examples, the additional power control offset is added to the payload size dependent offset within the power control equation. In some examples, the additional power control offset is a fixed offset configured by the network entity (e.g., the UE receives the additional power control offset from the network entity). In some examples, the fixed offset is set to a first value in response to the number of UCI bits being less than or equal to a threshold number of bits and a second value in response to the number of UCI bits being greater than the threshold number of bits, where the second value is greater than the first value. In some examples, the fixed offset is set to a first value in response to the encoder type being a first encoder type and a second value in response to the encoder type being a second encoder type, where the second value is greater than the first value. In some examples, the first encoder type includes a Reed Muller encoder and the second encoder type includes a polar encoder.

In some examples, the additional power control offset is based on the payload type, where the payload type includes at least one a scheduling request, channel state information, or acknowledgement information. In some examples, the additional power control offset is added to a power control equation including the payload size dependent offset and the UE may calculate the transmit power using the power control equation. In some examples, the power control equation further includes an open loop power control parameter, a closed loop power control parameter, an uplink PUCCH format offset, a path loss parameter, and a bandwidth parameter. In some examples, the open loop power control parameter includes the additional power control offset and the open loop power control parameter is configured by the network entity. In some examples, the additional power control offset is a fixed offset configured by the network entity (e.g., the UE receives the additional power control offset from the network entity).

At block 1104, the UE may transmit the PUCCH at the transmit power to a network entity. For example, the communication and processing circuitry 1042, together with the transceiver 1010, antenna modules 1026, and power source 1028, shown and described above in connection with FIG. 10, may provide a means to transmit the PUCCH at the transmit power.

In one configuration, the UE includes means for configuring a transmit power of a physical uplink control channel (PUCCH), wherein the transmit power comprises a payload size dependent offset and an additional power control offset based on at least one of a payload type, a number of uplink control information (UCI) bits, or an encoder type and means for transmitting the PUCCH at the transmit power to a network entity. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, and/or 7, and utilizing, for example, the processes and/or algorithms described herein in relation to FIGS. 8, 9, and 11.

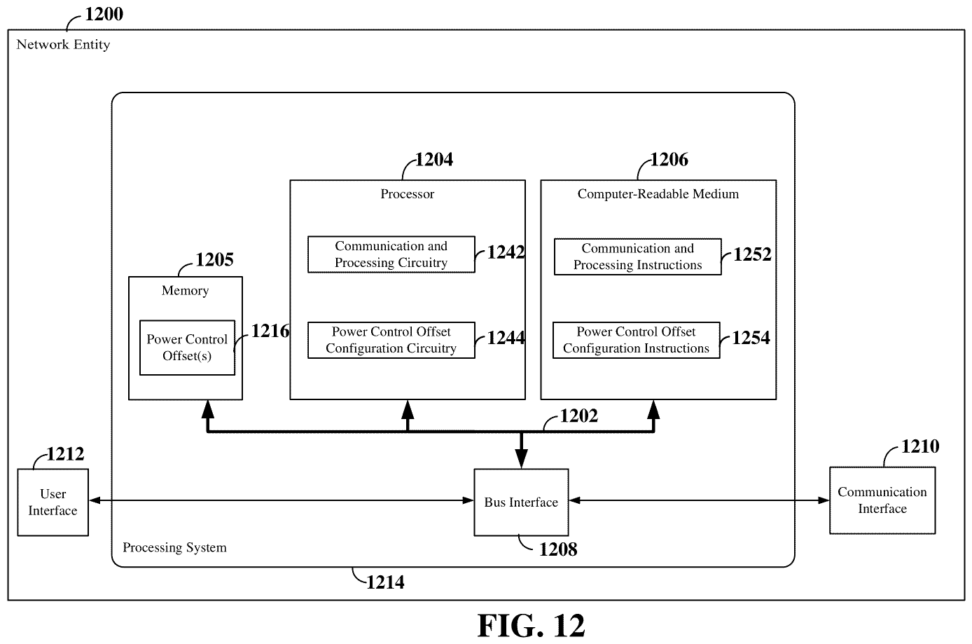

FIG. 12 is a block diagram illustrating an example of a hardware implementation of a network entity 1200 employing a processing system 1214 according to some aspects. The network entity 1200 may be, for example, a network entity or other network node illustrated in any one or more of FIGS. 1, 2, 8, and/or 9. For example, the network entity may be a base station (e.g., gNB, eNB) or other scheduling entity as illustrated in any one or more of FIGS. 1 and/or 2. A network entity may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. In addition, a network entity may be a stationary network entity or a mobile network entity.

In accordance with various aspects of the disclosure, an element, or any portion of an element, or any combination of elements may be implemented with a processing system 1214 that includes one or more processors, such as processor 1204. The processing system 1214 may be substantially the same as the processing system 1014 as shown and described above in connection with FIG. 10, including a bus interface 1208, a bus 1202, a memory 1205 (e.g., one or more memories), a processor 1204 (e.g., one or more processors), and a computer-readable medium 1206 (e.g., one or more computer-readable mediums). Accordingly, their descriptions will not be repeated for the sake of brevity. Furthermore, the network entity 1200 may include an optional user interface 1212 and a communication interface 1210 (e.g., wired or wireless), such as one or more transceivers or one or more network interfaces.

The processor 1204, as utilized in the network entity 1200, may be used to implement any one or more of the processes described below. In some examples, the memory 1205 may store one or more power control offsets 1216.

In some aspects of the disclosure, the processor 1204 may include communication and processing circuitry 1242 configured for various functions, including, for example, communicating with one or more wireless communication devices (e.g., UEs), a core network node, or other network entity. In some examples (e.g., in an aggregated base station architecture), the communication and processing circuitry 1242 may include one or more hardware components that provide the physical structure that performs processes related to wireless communication (e.g., signal reception and/or signal transmission) and/or signal processing (e.g., processing a received signal and/or processing a signal for transmission). In addition, the communication and processing circuitry 1242 may be configured to process and transmit downlink traffic and downlink control and receive and process uplink traffic and uplink control.

In some examples, the communication and processing circuitry 1242 may be configured to provide one or more power control offsets 1216 to a UE for configuration of a transmit power of a PUCCH. The communication and processing circuitry 1242 may further be configured to obtain the PUCCH sent at the transmit power. The communication and processing circuitry 1242. The communication and processing circuitry 1242 may further be configured to execute communication and processing software 1252 stored on the computer-readable medium 1206 to implement one or more functions described herein.

The processor 1204 may further include power control offset configuration circuitry 1244, configured to configure the one or more power control offsets 1216. For example, the one or more power control offsets 1216 may be based on at least one of a payload type, a number of uplink control information (UCI) bits, or an encoder type. In some examples, the power control offset 1216 is based on the number of UCI bits or the encoder type. For example, the power control offset 1216 may be configured to be an offset to a payload size dependent offset that may be configured by the UE. The power control offset may be added to a power control equation including the payload size dependent offset or may be added to the payload size dependent offset itself. In some examples, the power control offset is a fixed offset. For example, the fixed offset may be set to a first value in response to the number of uplink bits being less than or equal to a threshold number of bits and a second value in response to the number of uplink bits being greater than the threshold number of bits, where the second value is greater than the first value. In some examples, the fixed offset is set to a first value in response to the encoder type being a first encoder type and a second value in response to the encoder type being a second encoder type, where the second value is greater than the first value. For example, the first encoder type can include a Reed Muller encoder and the second encoder type can include a polar encoder.

In some examples, the power control offset 1216 is based on the payload type, where the payload type includes at least one a scheduling request, channel state information, or acknowledgement information. In some examples, the power control offset is configured to be added to a power control equation including an open loop power control parameter, a closed loop power control parameter, an uplink PUCCH format offset, a path loss parameter, a bandwidth parameter, and a payload size dependent offset. In some examples, the open loop power control parameter includes the power control offset. In some examples, the power control offset is a fixed offset. The power control offset configuration circuitry 1244 may further be configured to execute power control offset configuration software 1254 stored on the computer-readable medium 1206 to implement one or more functions described herein.

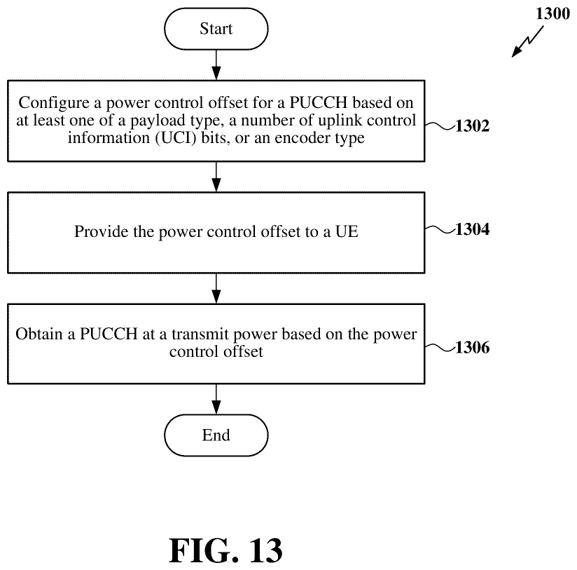

FIG. 13 is a flow chart illustrating an exemplary process 1300 for a network entity to configure a power control offset for a transmit power of a PUCCH according to some aspects. As described below, some or all illustrated features may be omitted in a particular implementation within the scope of the present disclosure, and some illustrated features may not be required for implementation of all embodiments. In some examples, the process 1300 may be carried out by the network entity 1200 illustrated in FIG. 12. In some examples, the process 1300 may be carried out by any suitable apparatus or means for carrying out the functions or algorithm described below.

At block 1302, the network entity may configure a power control offset for a PUCCH based on at least one of a payload type, a number of uplink control information (UCI) bits, or an encoder type. For example, the power control offset configuration circuitry 1244, shown and described above in connection with FIG. 12 may provide a means to configure the power control offset.

In some examples, the network entity may configure the power control offset based on the number of UCI bits or the encoder type. For example, the power control offset may be configured to be an offset to a payload size dependent offset that may be configured by the UE. The power control offset may be added to a power control equation including the payload size dependent offset or may be added to the payload size dependent offset itself. In some examples, the power control offset is a fixed offset. For example, the fixed offset may be set to a first value in response to the number of UCI bits being less than or equal to a threshold number of bits and a second value in response to the number of UCI bits being greater than the threshold number of bits, where the second value is greater than the first value. In some examples, the fixed offset is set to a first value in response to the encoder type being a first encoder type and a second value in response to the encoder type being a second encoder type, where the second value is greater than the first value. For example, the first encoder type can include a Reed Muller encoder and the second encoder type can include a polar encoder.

In some examples, the network entity may configure the power control offset based on the payload type, where the payload type includes at least one a scheduling request, channel state information, or acknowledgement information. In some examples, the power control offset is configured to be added to a power control equation including an open loop power control parameter, a closed loop power control parameter, an uplink PUCCH format offset, a path loss parameter, a bandwidth parameter, and a payload size dependent offset. In some examples, the open loop power control parameter includes the power control offset. In some examples, the power control offset is a fixed offset

At block 1304, the network entity may provide the power control offset to a UE. For example, the communication and processing circuitry 1242, together with the communication interface 1210, shown and described above in connection with FIG. 12 may provide a means to provide the power control offset to the UE.

At block 1306, the network entity may obtain a PUCCH at a transmit power based on the power control offset. For example, the communication and processing circuitry 1242, together with the communication interface 1210, shown and described above in connection with FIG. 12 may provide a means to obtain the PUCCH.

In one configuration, the network entity includes means for configuring a power control offset for a PUCCH based on at least one of a payload type, a number of uplink control information (UCI) bits, or an encoder type, means for providing the power control offset to a UE, and means for obtaining a PUCCH at a transmit power based on the power control offset. In one aspect, the aforementioned means may be the processor 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1204 is merely provided as an example, and other means for carrying out the described functions may be included within various aspects of the present disclosure, including but not limited to the instructions stored in the computer-readable storage medium 1206, or any other suitable apparatus or means described in any one of the FIGS. 1 and/or 2, and utilizing, for example, the processes and/or algorithms described herein in relation to FIGS. 8, 9, and 13.

The following provides an overview of aspects of the present disclosure:

Aspect 1: A method operable at a user equipment (UE), the method comprising: configuring a transmit power of a physical uplink control channel (PUCCH), wherein the transmit power comprises a payload size dependent offset and an additional power control offset based on at least one of a payload type, a number of uplink control information (UCI) bits, or an encoder type; and transmitting the PUCCH at the transmit power to a network entity.

Aspect 2: The method of aspect 1, wherein the additional power control offset is based on the number of UCI bits or the encoder type.

Aspect 3: The method of aspect 2, wherein the additional power control offset is added to a power control equation comprising the payload size dependent offset, wherein the configuring the transmit power comprises: calculating the transmit power using the power control equation.

Aspect 4: The method of aspect 3, wherein the additional power control offset is added to the payload size dependent offset within the power control equation.

Aspect 5: The method of any of aspects 2 through 4, wherein the additional power control offset is a fixed offset configured by the network entity.

Aspect 6: The method of aspect 5, wherein the fixed offset is set to a first value in response to the number of UCI bits being less than or equal to a threshold number of bits and a second value in response to the number of UCI bits being greater than the threshold number of bits, wherein the second value is greater than the first value.

Aspect 7: The method of aspect 5, wherein the fixed offset is set to a first value in response to the encoder type being a first encoder type and a second value in response to the encoder type being a second encoder type, wherein the second value is greater than the first value.

Aspect 8: The method of aspect 7, wherein the first encoder type comprises a Reed Muller encoder and the second encoder type comprises a polar encoder.

Aspect 9: The method of aspect 1, wherein the additional power control offset is based on the payload type, wherein the payload type comprises at least one a scheduling request, channel state information, or acknowledgement information.

Aspect 10: The method of aspect 9, wherein the additional power control offset is added to a power control equation comprising the payload size dependent offset, wherein the configuring the transmit power comprises: calculating the transmit power using the power control equation.

Aspect 11: The method of aspect 10, wherein the power control equation further comprises an open loop power control parameter, a closed loop power control parameter, an uplink PUCCH format offset, a path loss parameter, and a bandwidth parameter.

Aspect 12: The method of aspect 11, wherein the open loop power control parameter comprises the additional power control offset, wherein the open loop power control parameter is configured by the network entity.

Aspect 13: The method of any of aspects 9 through 11, wherein the additional power control offset is a fixed offset configured by the network entity.

Aspect 14: A user equipment (UE) comprising one or more memories and one or more processors coupled to the one or more memories, wherein the one or more processors are configured to perform a method of any of aspects 1 through 13.

Aspect 15: An apparatus configured for wireless communication comprising means for performing a method of any of aspects 1 through 13.

Aspect 16: A non-transitory computer-readable medium having stored therein instructions executable by one or more processors of a user equipment (UE) to perform a method of any one of aspects 1 through 13.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 7, 8-10, and/or 12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

What is claimed is:

1. A user equipment (UE), comprising:
one or more memories; and
one or more processors coupled to the one or more memories, wherein the one or processors are configured to:
configure a transmit power of a physical uplink control channel (PUCCH), wherein the transmit power comprises a payload size dependent offset and an additional power control offset based on at least one of a payload type, a number of uplink control information (UCI) bits, or an encoder type, and
transmit the PUCCH at the transmit power to a network entity.

2. The UE of claim 1, wherein the additional power control offset is based on the number of UCI bits or the encoder type.

3. The UE of claim 2, wherein the additional power control offset is added to a power control equation comprising the payload size dependent offset, wherein the one or more processors are further configured to:
calculate the transmit power using the power control equation.

4. The UE of claim 3, wherein the additional power control offset is added to the payload size dependent offset within the power control equation.

5. The UE of claim 2, wherein the additional power control offset is a fixed offset configured by the network entity.

6. The UE of claim 5, wherein the fixed offset is set to a first value in response to the number of UCI bits being less than or equal to a threshold number of bits and a second value in response to the number of UCI bits being greater than the threshold number of bits, wherein the second value is greater than the first value.

7. The UE of claim 5, wherein the fixed offset is set to a first value in response to the encoder type being a first encoder type and a second value in response to the encoder type being a second encoder type, wherein the second value is greater than the first value.

8. The UE of claim 7, wherein the first encoder type comprises a Reed Muller encoder and the second encoder type comprises a polar encoder.

9. The UE of claim 1, wherein the additional power control offset is based on the payload type, wherein the payload type comprises at least one of a scheduling request, channel state information, or acknowledgement information.

10. The UE of claim 9, wherein the additional power control offset is added to a power control equation comprising the payload size dependent offset, wherein the one or more processors are further configured to:
calculate the transmit power using the power control equation.

11. The UE of claim 10, wherein the power control equation further comprises an open loop power control parameter, a closed loop power control parameter, an uplink PUCCH format offset, a path loss parameter, and a bandwidth parameter.

12. The UE of claim 11, wherein the open loop power control parameter comprises the additional power control offset, wherein the open loop power control parameter is configured by the network entity.

13. The UE of claim 9, wherein the additional power control offset is a fixed offset configured by the network entity.

14. A method operable at a user equipment (UE), the method comprising:
configuring a transmit power of a physical uplink control channel (PUCCH), wherein the transmit power comprises a payload size dependent offset and an additional power control offset based on at least one of a payload type, a number of uplink control information (UCI) bits, or an encoder type; and
transmitting the PUCCH at the transmit power to a network entity.

15. The method of claim 14, wherein the additional power control offset is based on the number of UCI bits or the encoder type.

16. The method of claim 15, wherein the additional power control offset is added to a power control equation comprising the payload size dependent offset, wherein the configuring the transmit power comprises:
calculating the transmit power using the power control equation.

17. The method of claim 16, wherein the additional power control offset is added to the payload size dependent offset within the power control equation.

18. The method of claim 14, wherein the additional power control offset is based on the payload type, wherein the payload type comprises at least one a scheduling request, channel state information, or acknowledgement information, wherein the additional power control offset is added to a power control equation comprising the payload size dependent offset, wherein the configuring the transmit power comprises:
calculating the transmit power using the power control equation.

19. The method of claim 18, wherein the power control equation further comprises an open loop power control parameter, a closed loop power control parameter, an uplink PUCCH format offset, a path loss parameter, and a bandwidth parameter, wherein the open loop power control parameter comprises the additional power control offset, wherein the open loop power control parameter is configured by the network entity.

20. An apparatus configured for wireless communication, comprising:
means for configuring a transmit power of a physical uplink control channel (PUCCH), wherein the transmit power comprises a payload size dependent offset and an additional power control offset based on at least one of a payload type, a number of uplink control information (UCI) bits, or an encoder type; and
means for transmitting the PUCCH at the transmit power to a network entity.
